(19) United States
(12) Patent Application Publication
(10) Pub. No.: US 2009/0205557 A1
(43) Pub. Date: Aug. 20, 2009

(54) SYSTEM AND METHOD FOR IDENTIFYING A GARMENT

(75) Inventor: Paul Ullmann, Vienna (AT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,312

(22) PCT Filed: Feb. 15, 2006
(86) PCT No.: PCT/IB2006/050491

§ 371 Date: Aug. 15, 2007

(30) Foreign Application Priority Data
Feb. 18, 2005 (EP) 05300134.3

(51) Int. Cl. F21S 10/00

(52) U.S. Cl. 116/202

(57) ABSTRACT

The system comprises an optical device (4) emitting an optical signal, and identifying tags (6a, 6b), each identifying tag comprising an attachment portion for attachment to a garment, such as a sock (9a, 9b), and an identification portion having a predetermined optical characteristic, not easily recognizable by the human eye in ambient lighting conditions, the optical signal and the optical characteristic being matched so that the optical characteristic is easily recognizable by the human eye upon exposure of the identification portion to the optical signal.

### FIELD OF THE INVENTION

The invention relates to systems and methods for identifying garments.

### BACKGROUND OF THE INVENTION

After washing garments, it is a necessity to sort them, whether at the industrial washing scale or the smaller family circle scale. It might be troublesome and time-consuming to properly sort similar garments. For example, in the family circle, matching together two socks of a given pair from a set of washed garments, in particular if other similar pairs of different sizes or age were simultaneously washed, can prove difficult.

From the document US 2002/079249, there is known a system comprising an illumination source, a fluorescent bar-code label, a camera sensor suitable to read a bar code from the label (attached to a garment) under exposure to a light ray from the illumination source, and a computerized unit in order to obtain information about the garment from the read bar code.

However, since information is pre-encoded in the bar-code label, this system is not very adaptable. For each new wash, new labels have to be printed, corresponding to the garments which have not been previously washed. In addition, the same label will always have to designate the same garment. If information about a garment will change, a new label would have to be printed for that garment, or the computerized unit would have to be re-programmed so that the old label would provide with the appropriate new information. As a consequence, this system is hardly usable in the family circle, where re-usability is a key feature for such a system.

### SUMMARY OF THE INVENTION

It is an object of the present invention to provide an easily reusable system for obtaining information about a garment.

To this end, the invention provides a system for identifying a garment comprising:
an optical device adapted to emit an optical signal, and
at least one identifying tag, each identifying tag comprising an attachment portion for attachment to a garment and an identification portion having at least one predetermined optical characteristic which is not easily recognizable by the human eye in ambient lighting conditions,

said optical signal and said optical characteristic being matched so that said optical characteristic is easily recognizable by the human eye upon exposure of said identification portion to said optical signal.

Such a system makes it possible to sort the garment provided with said tag from other garments. In addition, the tags could for example be used for identifying both socks of a given pair of socks during a first washing, or for identifying all garments belonging to a given person of a family, during a subsequent washing. The tags are thus easily reusable.

In addition, the system is easy to use and cheap, since it does not need a camera and specialised computerized unit, nor a specialised printing machine.

In particular embodiments of the system, one might also use the features defined in the dependent system claims.

According to another aspect, the invention provides a method for identifying a garment comprising the following steps:
an optical signal is emitted by an optical device,
an optical characteristic of at least one identifying tag is detected, based on the fact that each identifying tag comprises an identification portion provided with said optical characteristic, which is not easily recognizable by the human eye in ambient lighting conditions, and that said optical signal and said optical characteristic are matched so that said optical characteristic is easily recognizable by the human eye upon exposure of said identification portion to said optical signal, and
a garment to which said identifying tag is attached is identified based on the detected optical characteristic.

In particular embodiments of the method, one might also use the features defined in the dependent method claims.

### BRIEF DESCRIPTION OF THE DRAWINGS

Other features and advantages of the present invention will be apparent from the following description, drawings and claims.

In the drawings:

FIG. 1 is a schematic view illustrating an embodiment of the system of the invention,

FIG. 2 is a schematic view of an example of an identifying tag,

FIGS. 3 and 4 are schematic views illustrating the use of the system of FIG. 1,

FIGS. 5a to 5e are schematic views showing different possible embodiments for identifying tags, and

FIGS. 6a to 6d are schematic views showing other possible embodiments for the identifying tags.

### DETAILED DESCRIPTION OF THE INVENTION

The invention described below provides an easily customizable system for identification of garments. In the drawings which illustrate embodiments of such a system, corresponding or similar elements bear the same reference numbers.

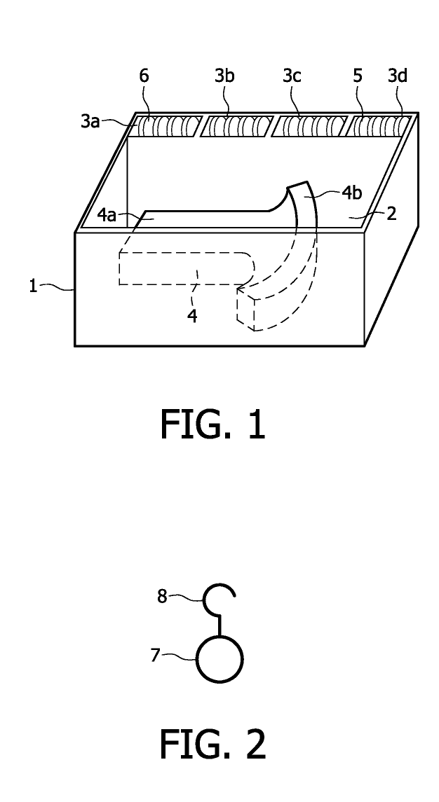

In FIG. 1, an embodiment of a system according to the invention is drawn. FIG. 1 shows a package 1 comprising a plurality of compartments 2, 3a, 3b, 3c and 3d. Compartment 2 encloses an optical device 4 suitable for emitting an optical signal, such as for example a low-pressure mercury lamp suitable for emitting a fluorescent ultra-violet (UV) optical signal. The lamp 4 could for example be hand-held, could be controllable in either one of an on- and an off-state, and could comprise a grasping portion 4a and a light emitting portion 4b opposite to the grasping portion 4a. The emitted light could have a time-modulated intensity. For example, the emitted light can have a modulation frequency lying in an area in which the human eye is sensitive, such as for example 2-5 Hz.

The package 1 also comprises a given number (e.g. 4, as shown in FIG. 1) of sets 5 of identifying tags 6. Each set 5 is held in a respective compartment 3a, 3b, 3c, 3d and comprises a plurality (for example from 1 to 10 and more preferably from 2 to 10) of similar identifying tags 6. In one embodiment, all the identifying tags 6 of a given set 5 are said similar in the meaning that they are provided with a given optical characteristic. For example, in the case of a fluorescent UV lamp 4, all the identifying 5 tags 6 of a given set 5 exhibit the same fluorescent colour under exposure to the optical signal emitted by lamp 4.

As shown in FIG. 2, each identifying tag 6 comprises an identifying portion 7, which is for example a flat thin sheet of plastic, and an attachment portion 8 for attachment to a garment. Possibly, the identifying portion of a tag 6 is made of a translucent material, so that the tag is hardly visible to an untrained human eye. This enables conventional use of the garment in daylight conditions. For example, the identifying portion 7 of a tag 6 could be made of polystyrene, nylon, polyethersulfone or other suitable plastic material, in particular suitable to resist the range of temperatures commonly encountered during a washing or a drying cycle of a garment.

During manufacture, suitable fluorescent pigments may be added to the plastic of the identifying portions of the tags, in order to provide the suitable optical characteristic to the identifying tag 6. For example, the tags being described comprise about 0.1% of an organic pigment, such as “lumilux blue cd 307”, which is commercially available from Riedel-de-Haen, for providing a blue fluorescent colour. The concentration of pigment could for example range from 0.01% to 1%. Other lumilux pigments could be used for providing other colours, in particular for a second set 5 of tags 6. The optical characteristic is thus hardly recognizable under ambient lighting conditions. In practice, any suitable fluorescent pigment, organic or anorganic, could be used.

If the system comprises a plurality of sets of tags, the first set of tags, which has just been described, may be contained in a first compartment 3 of the package 1, and a second set of tags may be enclosed in a second compartment 3b of the package 1. The tags 6 of the second set all exhibit the same optical characteristic, which is different from the optical characteristic exhibited by the tags of the first set. For example, the identifying portion of the second set of tags comprises an UV fluorescent pigment which is different from the one comprised in the identifying portion of the tags of the first set. For example, the tags of the second set comprises an organic pigment “lumilux green cd 333” also available from Riedel-de-Haen, providing for green UV fluorescence.

The attachment portion 8 could be a hook, as roughly represented in FIG. 2, of suitable size and rigidity in order to remain attached to a garment during normal washing and drying cycles, and possibly during the normal use of the garment, if the system user chooses to leave the tags attached to the garment during their normal use. However, the attaching portion 8 is not necessarily realized in the shape of a hook, but could for example be realized in the form of a stickable portion on the back (not shown) of the identifying portion 7 of the tag. The sticking portion could be designed so that the identifying tag could be permanently or removably attached to any suitable part of the garment.

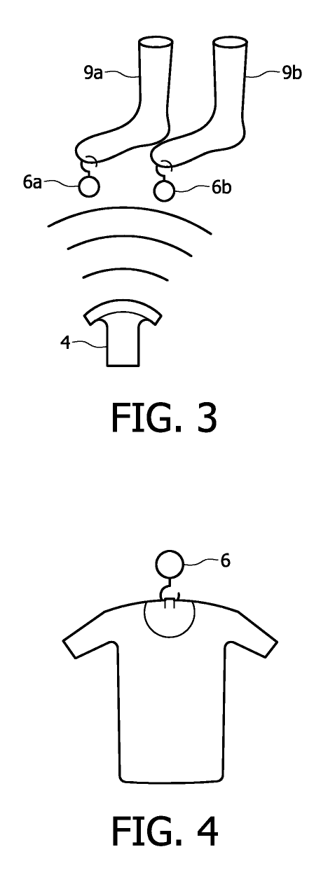

A description of the system in use will now be given with reference to FIG. 3. Let us assume the following: A first tag 6a has been attached to a first garment, such as for example a first sock 9a. A second tag 6b was similarly attached to a second garment, such as a second sock 9b. In practice, both socks of a given pair will have identifying tags belonging to a given set attached thereto before washing. However, after washing, it is unsure if, when sorting the garments, socks 9a and 9b really belong to said pair. For example, four or five similar pairs of socks, but of different sizes (because they belong to different people of the same family) or ages have been washed simultaneously. With the system described in relation to FIGS. 1 and 2, the house person will turn the lamp on and first illuminate the identifying portion 7 of the tag 6a, attached to the sock 9a, with the UV lamp 4, so that the optical characteristic of the tag 6a (its fluorescent colour) is revealed. The optical characteristic is then easily recognizable by the human eye. If the light emitted from the lamp has a time-modulated intensity, the fluorescent colour appears “flashing” and is thus more easily spotted by the human eye, even with the same luminosity, than with a constant intensity light.

Acting in the same way for the identifying tag 6b of the sock 9b, the house person will be in a position to recognize if the fluorescent colour emitted by the tag 6b under exposure to the optical signal from UV lamp 4 is the same as the one which has been previously emitted by the first tag 6a, in which case it means that the two socks belong to the same pair. Should the colors be different, it means that the two socks belong to two different pairs. Repeating this operation with all identified garments, an easy sorting of the garments is made possible. The lamp could be turned off and put back into the package 1.

After sorting, the identifying tags 6 could be removed from the garments and placed back in right order into the package 1. Alternately the tags could be left permanently on the garments, for example if they were attached by sticking the back face of the identifying portion 7 on the garments. If the tags are permanently attached to the garment, it is not necessary for the house person to attach the tags to the garments before each washing and to remove the same after each washing. Preferably, the tags would then be placed in a position of the garment where they are not visible in normal use condition of the garment (for example a foot portion of a sock) and/or be made of a translucent material. It is also possible that the identifying tag will be integrated into the garment during manufacture of the garment.

Another possible example of use of the described system is the sorting of garments belonging to a given person of the household. As shown in FIG. 4, the identifying tags 6 are not necessarily attached to socks only. They could also be attached to all washed garments: for example all the garments of a given person of the household will be provided with identifying tags of a respective set. This could be very useful, for example, in a family with numerous brothers and sisters, who might often have similar clothes. By identifying all the clothes belonging to Joe with a first fluorescent colour, those belonging to Jack with a second fluorescent colour, those belonging to William with a third fluorescent colour and those belonging to Averell with a fourth fluorescent colour, the sorting of the clothes will be much easier.

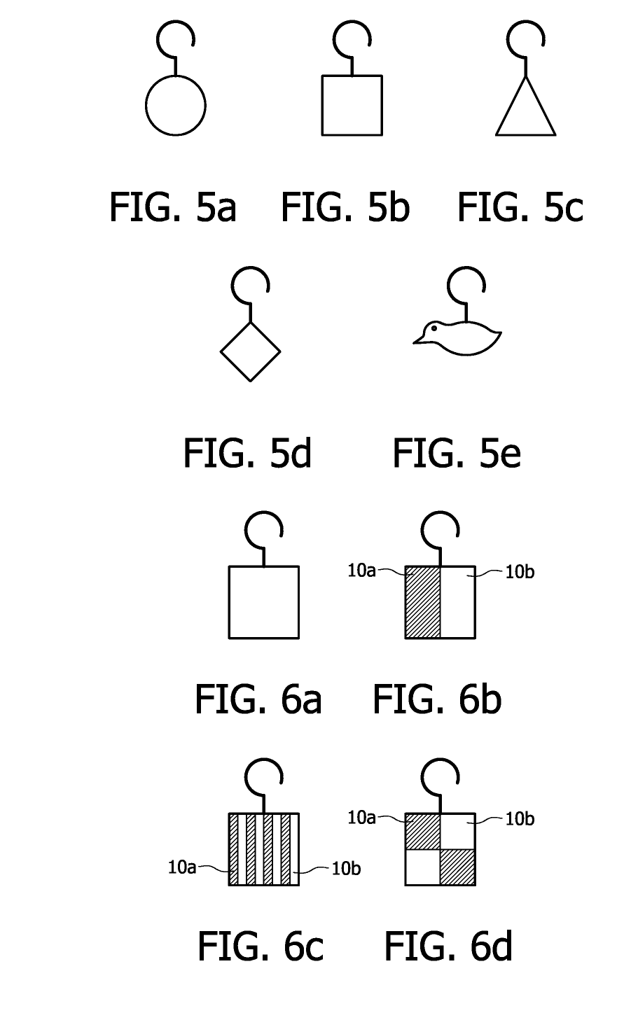

As shown schematically in FIGS. 5a to 5e, in addition to the distinction between two tags as a function of their optical characteristic (fluorescent colour), the tags of different sets could also exhibit different shapes, which will make it easier to distinguish between two different sets.

In another embodiment, the tags of a given set (exhibiting all the same fluorescent colour) may be provided with different shapes in order to provide additional information to the house person. In this embodiment, each tag would provide two kinds of information: one indicated by its fluorescent colour, and the other one indicated by its shape.

Although only two examples of suitable organic pigments were given in the above description, any suitable colour or set of colours could be obtained by blending suitable pigments. As shown schematically in FIGS. 6a to 6d, a huge number of different sets could be obtained by using bicolour or multicolour tags. By colouring two different portions 10a, 10b of all the tags of a given set in different ways, one could obtain additional information about the garments identified by this set. In another embodiment, one set is made of striped tags and another set is made of checked tags, possibly from different fluorescent colour, in order to provide for better identification of the garment. Although multicolour tags are described in relation with square tags, they could also be applied to any other shape of the tags, or even be combined with the embodiment of FIGS. 5a to 5e in order to provide with a triple information about the garment: one related to fluorescent colour, one related to shape, and one related to the multicolour pattern.

There are numerous ways of implementing the invention. In this respect, the drawings are very diagrammatic, each representing only one possible embodiment of said invention. Thus, the remarks made herein before demonstrate that the detailed description, with reference to the drawings, illustrates rather than limits the invention. There are numerous alternatives, which fall within the scope of the appended claims. The word “comprising” does not exclude the presence of other elements or steps than those listed in a claim. The word “a” or “an” preceding an element or step does not exclude the presence of a plurality of such elements or steps.

1-18. (canceled)

19. A system for identifying garments comprising:
an optical device adapted to emit an optical signal, at least a first set of identifying tags, said first set comprising at least one identifying tag and a further identifying tag, said tags each comprising an attachment portion for attachment to a garment and an identification portion having at least one predetermined optical characteristic, which is not easily recognizable by the human eye in ambient lighting conditions, all identifying tags of said first set being provided with the same optical characteristic, and
at least a second set of at least two identifying tags, each identifying tag of said second set comprising an attachment portion for attachment to a garment and an identification portion having at least one other predetermined characteristic different from the optical characteristic of said one identifying tag, all identifying tags of said second set being provided with the same other optical characteristic, said other optical characteristic being not easily recognizable by the human eye in ambient lighting conditions,
said optical signal and said optical characteristics being matched so that said optical characteristics are easily recognizable by the human eye upon exposure of said identification portion to said optical signal.

20. A system according to claim 19, wherein said optical signal is an ultra-violet signal and said optical characteristic is a fluorescent colour emitted under impingement of said ultra-violet signal.

21. A system according to claim 19, wherein said tags are translucent in ambient lighting conditions.

22. A system according to claim 19, wherein said tags are made of a heat-resistant material.

23. A system according to claim 19, wherein said tags are made of a plastic material.

24. A system according to claim 19, wherein the identification portion of the identifying tags of said first set comprise at least a first area and a second area, said second area being separate from said distinct area, said first and second areas exhibiting respectively a first and a second optical characteristic, said second optical characteristic being different from said first optical characteristic.

25. A system according to claim 19, wherein said optical device is adapted to emit an optical signal having a time-modulated intensity.

26. A system according to claim 19 further comprising a washing machine.

27. A system according to claim 19, wherein each of said tags is an integral part of a garment.

28. Sets of identifying tags for use in a system according to claim 19, said system having all the features recited in that claim 19.

29. A method for identifying garments comprising the following steps:
an optical signal is emitted by an optical device, and
an optical characteristic of at least one identifying tag is detected, based on the fact that each identifying tag comprises an identification portion provided with said optical characteristic, which is not easily recognizable by the human eye in ambient lighting conditions, and that said optical signal and said optical characteristic are matched so that said optical characteristic is easily recognizable by the human eye upon exposure of said identification portion to said optical signal,
an optical characteristic of a further identifying tag is detected, said one and said further identifying tags being part of a first set of identifying tags being all provided with the same optical characteristic,
an optical characteristic of at least two other identifying tags is detected, said two other identifying tags being part of a second set of identifying tags being provided with the same optical characteristic, different from the optical characteristic of said one identifying tag, and
garments to which said identifying tags are attached are identified based on the detected optical characteristics.

30. A method according to claim 29, wherein said optical signal is emitted with a time-modulated intensity.

31. A method according to claim 29, wherein garments to which said tags are attached are sorted according to said optical characteristics
